(19) United States
(12) Patent Application Publication
(10) Pub. No.: US 2009/0000852 A1
(43) Pub. Date: Jan. 1, 2009

(54) Silent Chain with Asymmetric Involute Profile

(75) Inventor: Surendar Shawn Paul, Farmington Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/771,404

(22) Filed: Jun. 29, 2007

(51) Int. Cl. B60K 17/04; F16G 13/04

(52) U.S. Cl. 180/373; 474/212

(57) ABSTRACT

A chain link for a silent-type endless chain comprising a plate member having opposing first and second surfaces defining two apertures therethrough and two toes joined at a root. Each toe has an asymmetrical profile defined by a first flank joined to a second flank at a crest wherein the first flanks have a high-pressure involute angle and the second flanks have a low-pressure involute angle that is distinct from the high-pressure involute angle. The first flanks are oriented in a first direction and configured to engage with a plurality of asymmetrical sprocket teeth to transmit power in a first direction. The second flanks are oriented in a second direction distinct from the first and configured to engage with the plurality of asymmetrical sprocket teeth to transmit power in a second direction.

### TECHNICAL FIELD

The present invention relates generally to chain drive systems, and more particularly to silent-type endless power transmission chains comprised of interleaved sets of inverted-tooth links engaged with driving and driven sprockets, with the links being of asymmetrical construction.

### BACKGROUND OF THE INVENTION

A chain drive is a system for continuously transmitting mechanical power from one rotating element to another. Also referred to as chain-and-sprocket assemblies, such systems generally comprise a driving sprocket spaced apart from a driven sprocket, both intermeshed with an endless power transmission chain.

Chain drives are widely used in automotive, aeronautical, and industrial applications. In regards to the former, chain drives are utilized for ignition timing (e.g., to drive an overhead camshaft valvetrain), offsetting engine distortion (e.g., to drive an engine mounted balancer), as well as for the transfer of power from the engine to the transmission, from the transmission to the transfer case (e.g., on a four-wheel drive platform), etc. Noise, vibration and harshness (NVH) generated by a power transmission chain intermeshing with a sprocket is a long recognized problem. The most significant sources of noise in operating a chain drive results from the recurring impact and rubbing between mating members of the chain and sprockets as they engage with one another.

One type of endless power transmission chain is known as a “silent chain”, comprising sets of inverted tooth links interleaved in an endless fashion. The sets are assembled from several chain links disposed alongside of (or adjacent to) one another, and pivotably joined by round pins or rocker-joint pins, received by mating apertures in each link. The links of a silent chain traditionally have a pair of teeth or toes, which are defined by an outside flank connected to an inside flank at the tooth's crest. The inside flanks of adjacent teeth are connected at the tooth's root. When wrapped around the driving and driven sprockets in a chain drive system, the links of an endless silent chain are interspersed with the teeth of the sprockets.

The intermeshing teeth of the sprockets and silent chain enable the transmission of power from the driving sprocket through the endless silent chain to the driven sprocket. Noise generated during engagement of a silent chain tooth with a sprocket tooth is dispersed and attenuated by the configuration and arrangement of the engaging flank surfaces of the individual chain tooth with the engaging surface of the corresponding sprocket tooth, both designed to engage with minimal sliding or impact.

Historically, silent chains have been constructed from chain links that have identical shapes and are all oriented in the same direction. In other words, the configuration of the individual chain links or chain link sets are generally identical and symmetrical. For example, the contour of the inside tooth flank has a substantially symmetrical convex curve with the contour of the outside tooth flank, the inside and outside flanks of each chain link tooth being generally indistinguishable from tooth to tooth. Differences in tooth design and symmetry can affect the operation of the link within the chain structure.

### SUMMARY OF THE INVENTION

Provided generally is a chain drive system having one or more driving sprockets and one or more driven sprockets interconnected by a silent-type endless power transmission chain. More specifically, an asymmetric dual-pressure-angle silent chain is provided that optimizes the individual flank profiles of each toe independently of each other to take advantage of the different mesh loading conditions on each flank. In doing so, the present invention offers improved bending fatigue strength, compressive fatigue strength, and wear performance for the silent endless power transmission chain. In addition, the present invention provides for reduced separating loads and tooth jump potential during normal and extreme operating conditions, which improves chain efficiency and prolongs the operational life expectancy of the chain drive system.

In accordance with one embodiment of the present invention, a chain drive system is provided having one or more driving sprockets, one or more driven sprockets, a silent chain, and a plurality of joining pins. The driving sprockets have a first plurality of asymmetrical sprocket teeth disposed about an outer periphery of the driving sprockets. Similarly, the driven sprockets have a second plurality of asymmetrical sprocket teeth disposed about an outer periphery of the driven sprockets.

In accordance with a preferred embodiment of the present invention, the silent chain is composed of a plurality of adjacent rows of interleaved chain links. Each chain link has substantially opposing first and second surfaces that define at least two apertures therethrough, preferably positioned in a longitudinal direction. Each chain link also has at least two toes that preferably extend substantially orthogonally to the longitudinal direction. The two toes are joined at a root and have an asymmetrical profile defined by a first flank joined to a second flank at a crest. The crest preferably has a substantially flat portion. The first flanks have a high-pressure involute angle sufficient to reduce contact stresses during engagement with the first and second pluralities of asymmetrical sprocket teeth. The second flanks have a low-pressure involute angle that is distinct from the high-pressure involute angle and sufficient to reduce separating loads during engagement with the first and second pluralities of asymmetrical sprocket teeth.

The first flank of each toe is preferably oriented in a first direction and is configured to engage with the first and second pluralities of asymmetrical sprocket teeth to transmit power between the driving and driven sprockets in the first direction. In a similar regard, the second flank of each toe is oriented in a second direction, which is distinct from the first direction, and configured to engage with the first and second pluralities of asymmetrical sprocket teeth to transmit power between the driving and driven sprockets in a second direction. Optimally, the low-pressure involute angle is 26 degrees and the high-pressure involute angle is 31 degrees.

Each chain link is preferably a substantially flat, unitary plate member that is preformed from a tempered metallic material. A plurality of joining pins are disposed in the apertures of the chain links to pivotably interconnect the rows of interleaved chain links in an endless manner to thereby define the silent chain.

It is further preferred that the silent chain also include a plurality of guide links disposed laterally along the outer sides of the rows of interleaved chain links. The guide links are configured to maintain lateral alignment of the silent chain with the driving and driven sprockets during operation of the chain drive system.

The above features and advantages, and other features and advantages of the present invention will be readily apparent from the following detailed description of the preferred embodiments and best modes for carrying out the invention when taken in connection with the accompanying drawings.

### BRIEF DESCRIPTION OF THE DRAWINGS

FIG. 1 is a schematic side-view of a portion of a chain drive system illustrating the engagement of an endless silent power transmission chain with a sprocket in accordance with the present invention;

FIG. 2 is a plan view of a segment of the endless silent power transmission chain of FIG. 1; and

FIG. 3 is an enlarged side-view of a single link plate from the endless silent power transmission chain of FIGS. 1 and 2.

### DESCRIPTION OF THE PREFERRED EMBODIMENTS

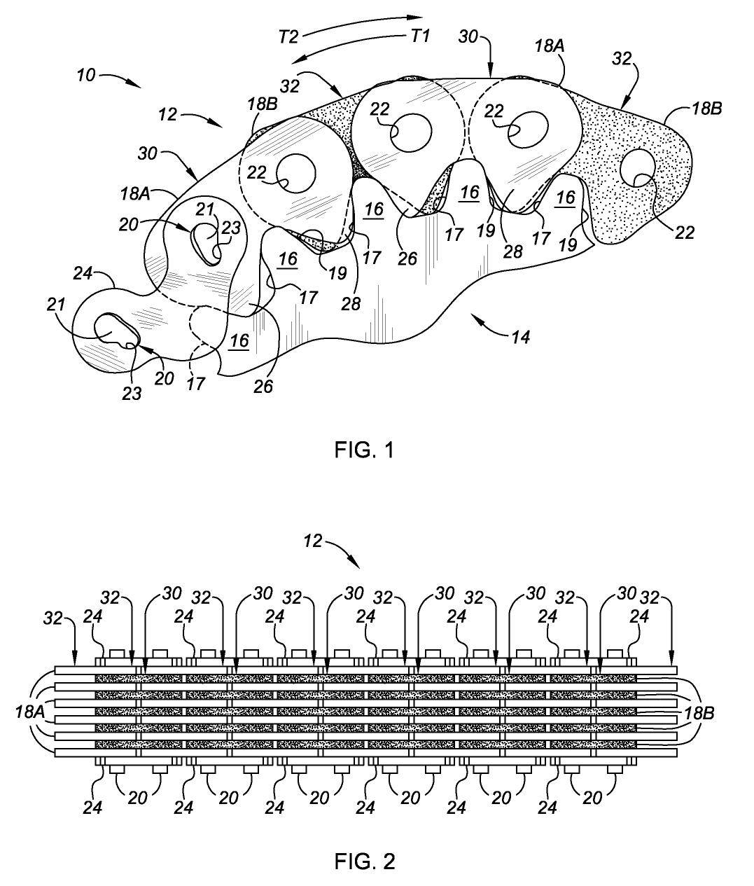

Referring to the drawings, wherein like reference numbers refer to the same or similar components throughout the several views, FIG. 1 is a schematic side-view of a portion of a chain drive system, identified generally as 10, in accordance with the present invention. The chain drive system of FIG. 1 includes an endless silent power transmission chain (hereinafter “silent chain”), identified generally as 12, and a plurality of driving and driven sprockets, represented collectively herein as sprocket 14. Although not illustrated herein, the complete chain drive system 10 includes two or more sprockets having the same or varying diameters and teeth counts. In a similar regard, the sprocket teeth may be evenly or unevenly spaced, and may have identical or varying profiles.

The sprocket 14 rotates about a driving or a driven shaft (neither shown herein), and includes a plurality of teeth 16 spaced generally equidistant from one another about the outer periphery of the sprocket 14. It is preferred that each tooth 16 of the sprocket 14 of FIG. 1 has an asymmetrical profile. As used herein, the terms “asymmetric” and “asymmetrical” should be defined or interpreted as identifying a component or element with a geometric profile that is not identical on both sides of a center line. For instance, in FIG. 1, the left flank 17 of each tooth 16 is preferably not geometrically identical to the corresponding right flank 19 of that same tooth 16.

Referring now to both FIGS. 1 and 2, the silent chain 12 is fabricated from a plurality of first and second chain link sets or ranks 30, 32, respectively. As best seen in FIG. 2, the first link set 30 consists of a plurality of laterally aligned, inverted and joined first chain links 18A (unshaded) interleaved and juxtaposed with a plurality of laterally aligned, inverted and joined second chain links 18B (shaded) that define the second link set 32.

Guide links 24 are provided at opposing sides of the interleaved first and second link sets 30, 32, intended to maintain the lateral alignment of the silent chain 12 on the sprocket 14. The guide links 24 are illustrated in FIGS. 1 and 2 along the outside of the silent chain 12, and more clearly shown in FIG. 1 as having no driving engagement with the teeth 16 of the sprocket 14. Recognizably, an inside guide link (not shown) may also be incorporated into the silent chain 12; however, the teeth 16 of the sprocket 14 would require corresponding grooves (not shown) to accommodate the inside guide links. Additionally, a chain tensioner (not shown) may also be included in the drive chain system 10 to maintain the planar alignment of the silent chain 12 with the sprocket 14.

Adjacent sets of links are joined by a pivot means, preferably in the nature of round pins 20, received by operatively aligned apertures 22, 23 in each of the first and second chain links 18A, 18B and corresponding guide link 24, respectively. Each link 18A, 18B has at least two apertures 22; each link 18A, 18B being configured to operatively mate with an aperture 22 in two respective links (as shown in FIG. 2.) The ends 21 of the round pins 20 are preferably shaped (e.g., by work hardening) to maintain the integrity of the silent chain 12 assembly. The represented embodiment of the pivot means as round pins 20 is clearly intended as exemplary, and thus should not be considered limiting. Accordingly, the pivot means could alternatively comprise of, by way of example, locker-joint pins (not shown) or rocker pins (not shown).

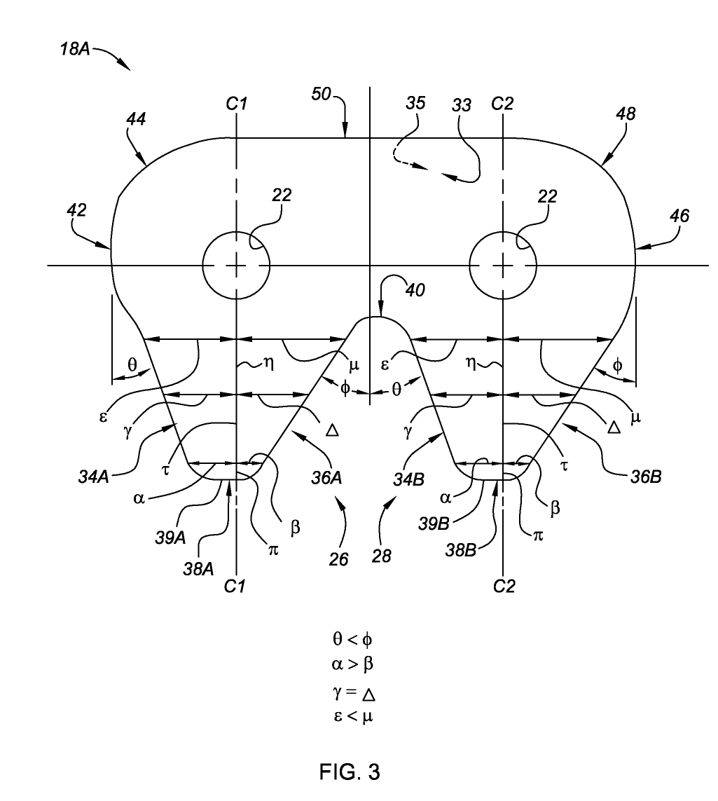

FIG. 3 provides an enlarged side-view of a single chain link 18A from the silent chain 12 of FIGS. 1 and 2. Of particular importance, the first and second chain links 18A, 18B have substantially identical geometric profiles, regardless of variations in shading or orientation. It should be understood that the embodiments provided in FIGS. 1 and 2 are merely exemplary of the present invention. The figures are not to scale, and certain features are exaggerated or eliminated to show details of particular components or elements. Therefore, FIGS. 1 and 2 are not to be interpreted as limiting, but merely as a basis for the claims and as a representative basis for teaching one skilled in the art to variously employ the present invention. Consequently, the geometric profile for both the first and second chain links 18A, 18B will be described collectively hereinafter with regards to chain link 18A.

Ideally, the link 18A is a unitary, preformed, substantially-flat plate member having a first surface 33 substantially opposing a second surface 35. It is further preferred that each link 18A is fabricated from a material known to have a suitable strength for its intended use, e.g., cold rolled steel, hot dipped galvanized steel, stainless steel, aluminum, and the like, and may be finished with an anti-corrosive, highly durable coating (e.g., dichromate paint, zinc plating, etc., not shown.) It is also within the scope of the present invention that each link 18A incorporates rounded or beveled edges, and has varying cross sections.

Each link 18A includes first and second spaced toes 26, 28, respectively. The first and second toes 26, 28 are each defined by a left flank 34A, 34B, connected to a right flank 36A, 36B at a crest 38A, 38B, respectively. The first and second toes 26, 28 are respectively bisected in FIG. 3 by centerlines C1, C2 to more clearly differentiate the profile of the left flank 34A, 34B from the right flank 36A, 36B. The right flank 36A of the first toe 26 is joined to the left flank 34B of the second toe 28 at a root 40. The left flank 34A of the first toe 26 is joined to a substantially flat upper surface 50 of the link 18A by a substantially flat left edge 42 and a left chamfered portion 44, whereas the right flank 36B of the second toe 28 is joined to the upper surface 50 by a substantially flat right edge 46 and a right chamfered portion 48. The first and second toes 26, 28 are substantially flat along at least a portion 39A, 39B, of the crest 38A, 38B, respectively. Although depicted as separate elements in FIG. 3, the structure of the first and second toes 26, 28 are identical; thus, for reasons of brevity, the first and second toes 26, 28 will both be described with regards to the first toe 26 only.

In accordance with the embodiment of FIG. 3, the profile of the left flank 34A, of each link 18A is geometrically dissimilar to the profile of the respective right flank 36A across centerlines C1. More specifically, the left flank 34A has a low-pressure angle, identified in FIG. 3 by the Greek letter θ, whereas the right flank 36A has a high-pressure angle, identified in FIG. 3 by the Greek letter Φ. As will become more apparent from the description hereinbelow, the design of the asymmetric dual-pressure angle toes 26, 28 described herein takes advantage of inherent variations in mesh loading conditions on the left and right flanks 34A, 36A, optimizing the flank angles θ, Φ independently of each other. In this regard, the low-pressure angle θ is preferably 26 degrees and the high-pressure angle Φ is 31 degrees. The higher-pressure flank-angle Φ offers improved bending fatigue strength, compressive fatigue strength, and wear performance, while the lower-pressure flank-angle θ reduces separating loads and tooth jump potential, thereby improving chain efficiency and extending the operational life expectancy of the chain drive system 10. Recognizably, the orientation of the left 34A, 34B and right flanks 36A, 36B of the first and second toes 26, 28 as depicted in FIG. 3 is purely exemplary and, therefore, is interchangeable without departing from the scope of the present invention.

According to the preferred embodiment of FIG. 3, the left flank 34A is made up of a single involute profile, and the right flank 36A is made up of a different single involute profile, wherein the difference between the profile angles θ and Φ of the two flanks 34A, 36A is fixed. Alternatively, each flank 34A, 36A may also be a blend of multiple involute profiles, with a fixed difference between the two flanks 34A, 36A. With specific regards to the left flank 34A, the reference Greek letters α, γ, and ε are intended as general metrics indicative of the distances between the profile periphery of the left flank 34A and the centerline C1, while navigating from the crest 38A, towards the root 40 between the two toes 26, 28. In a similar regard, with respect to the right flank 36A, the reference letters β, Δ, and μ are intended as general metrics indicative of the distances between the profile periphery of the right flank 36A and the centerline C1, while navigating from the crest 38A towards the root 40 between the two toes 26, 28.

In the embodiment illustrated in FIG. 3, at a distance π away from the crest 38A, the distance α from the periphery of left flank 34A to the centerline C1 is greater than the distance β from the periphery of the right flank 36A to the centerline C1. Traversing an additional distance of τ (i.e., τ+π) away from the crest 38A, the distance γ from the periphery of left flank 34A to the centerline C1 is equal to the distance Δ from the periphery of the right flank 36A to the centerline C1. Finally, traversing an additional distance of η (i.e., η+τ+π) away from the crest 38A, the distance ε from the periphery of left flank 34A to the centerline C1 is less than the distance μ from the periphery of the right flank 36A to the centerline C1.

Referring now to both FIGS. 1 and 3, when a portion of the silent chain 12 is wrapped around the sprocket 14, as shown in FIG. 1, the first and second toes 26, 28 of each link 18A of the silent chain 12 are interspersed in meshing engagement with the teeth 16 of the sprocket 14. The intermeshing engagement of the teeth 16 of sprocket 14 with the toes 26, 28 of silent chain 12 enables the chain drive system 10 to transmit power either from the sprocket 14 (as the driving sprocket) to one or more driven sprockets, or from a driving sprocket to the sprocket 14 (as a driven sprocket.)

In transmitting torque through endless power transmission chains, a sudden and large fluctuation in the load (e.g., a reverse torque from the driving sprocket) will change the instantaneous tension on the chain, which may cause a chain to “jump tooth”. Tooth jump is similar in concept to the slipping of a power transmission belt in a belt-drive application. In particular, during a “jump tooth” occurrence in a chain drive application, the endless power transmission chain misses a sprocket tooth and typically settles on the next tooth. A “jump tooth” occurrence may cause the chain to stretch, increasing the likelihood of a reoccurrence of tooth jump. Repeated tooth jumping in a chain drive system may consume a portion of the expected operation life of a chain (e.g., diminishing its ability to efficiently transmit torque.) Mating the asymmetrical involute profiles of the two flanks 34A, 34B and 36A, 36B of each toe 26, 28 of the silent chain 12 with the asymmetric teeth 16 of the sprocket 14 increases resistance to tooth jump.

When the direction of torque reverses in the chain drive system 10 (as illustrated in FIG. 1 by arrows T1 and T2), the instantaneous tension in the silent chain 12 after the reversal increases dramatically, before reducing to a steady state value. Due to the contact (or pressure) angle between the individual chain toes and corresponding sprocket teeth, there is a “separating” force that is effectively trying to push the two mating parts apart at the point of contact. Pressure angle is a function of the involute geometry found in the chain and sprocket teeth. For the same torque, a low pressure contact angle generates a lower separating load, requiring a larger load to cause a jump tooth occurrence in the chain drive system 10. Correspondingly, by using the lower-pressure angle θ for the contact flank (e.g., left flanks 34A, 34B) during reverse-direction, e.g., arrow T2, will reduce the separating loads at this high, transition tension, thereby reducing the likelihood of tooth jump. Furthermore, using the higher-pressure angle Φ for the contact flank (e.g., right flanks 36A, 36B) during normal-direction, e.g., arrow T1, will reduce the contact stress between the sprocket teeth 16 and chain link 18A toes 26, 28, improving wear performance. Additionally, the chain drive system 10 provides a net reduction in noise due to better contact and wear over the life of the silent chain 12.

While the best modes for carrying out the present invention have been described in detail herein, those familiar with the art to which this invention pertains will recognize various alternative designs and embodiments for practicing the invention within the scope of the appended claims.

1. A chain link adapted to be pivotably joined in an endless manner to thereby define a power transmission chain for a chain drive system having at least one sprocket with teeth, the chain link comprising:
a plate member having substantially opposing first and second surfaces defining at least two apertures therethrough and at least two toes joined at a root, each of said at least two toes having an asymmetrical profile defined by a first flank joined to a second flank at a crest;
wherein said first flanks have a first involute angle sufficient to reduce contact stresses during engagement with the teeth of the at least one sprocket; and
wherein said second flanks have a second involute angle that is different from said first involute angle and sufficient to reduce separating loads during engagement with the teeth of the at least one sprocket.

2. The chain link of claim 1, wherein said first involute angle is a high-pressure angle and said second involute angle is a low-pressure angle.

3. The chain link of claim 2, wherein said first flanks are oriented in a first direction and said second flanks are oriented in a second direction, said first direction being different from said second direction.

4. The chain link of claim 3, wherein said low-pressure involute angle is 26 degrees and said high-pressure involute angle is 31 degrees.

5. The chain link of claim 4, wherein said crest has a substantially flat portion.

6. The chain link of claim 5, wherein said plate member is substantially flat, unitary, and preformed from a tempered metallic material.

7. A silent chain adapted to operatively intermesh with at least two sprockets to transmit power therebetween, the silent chain comprising:
a plurality of rows of interleaved chain links, each of said chain links having substantially opposing first and second surfaces defining at least two apertures therethrough, and at least two toes joined at a root, each of said at least two toes having an asymmetrical profile defined by a first flank joined to a second flank at a crest;
a plurality of joining pins operatively disposed in said apertures and configured to pivotably interconnect said rows of interleaved chain links in an endless manner;
wherein said first flanks have a high-pressure involute angle and said second flanks have a low-pressure involute angle, said low-pressure involute angle being different from said high-pressure involute angle.

8. The silent chain of claim 7, wherein said first flanks are oriented in a first direction and said second flanks are oriented in a second direction, said first direction being different from said second direction.

9. The silent chain of claim 8, wherein said first flanks are configured to engage with the sprockets to transmit power in said first direction, and wherein said second flanks are configured to engage with the sprockets to transmit power in said second direction.

10. The silent chain of claim 9, wherein said low-pressure involute angle is 26 degrees and said high-pressure involute angle is 31 degrees.

11. The silent chain of claim 10, wherein said crest has a substantially flat portion.

12. The silent chain of claim 11, wherein said chain links are substantially flat, unitary, and preformed from a tempered metallic material.

13. The silent chain of claim 12, further comprising:
a plurality of guide links disposed laterally at outer sides of said rows of interleaved chain links and operatively configured to maintain lateral alignment of the silent chain with the at least two sprockets.

14. A chain drive system for a motorized vehicle, comprising:
at least one driving sprocket having a first plurality of asymmetrical teeth disposed about a driving sprocket periphery;
at least one driven sprocket having a second plurality of asymmetrical teeth disposed about a driven sprocket periphery;
a silent chain having a plurality of rows of interleaved chain links, each of said chain links having substantially opposing first and second surfaces defining at least two apertures therethrough, and at least two toes joined at a root, each of said at least two toes having an asymmetrical profile defined by a first flank joined to a second flank at a crest; and
a plurality of joining pins operatively disposed in said apertures and configured to pivotably interconnect said rows of interleaved chain links in an endless manner;
wherein said first flanks are oriented in a first direction and configured to engage with said first and second pluralities of asymmetrical teeth to transmit power in said first direction;
wherein said second flanks are oriented in a second direction distinct from said first direction and configured to engage with said first and second pluralities of asymmetrical teeth to transmit power in said second direction;
wherein said first flanks have a high-pressure involute angle and said second flanks have a low-pressure involute angle, said high-pressure involute angle being different from said low-pressure involute angle.

15. The chain drive system of claim 14, wherein said low-pressure involute angle is 26 degrees and said high-pressure involute angle is 31 degrees.

16. The chain drive system of claim 15, further comprising:
a plurality of guide links disposed laterally at outer sides of said rows of interleaved chain links and operatively configured to maintain lateral alignment of said silent chain with said driving and driven sprockets.

17. The chain drive system of claim 16, wherein said crest has a substantially flat portion.

18. The chain drive system of claim 17, wherein said chain links are substantially flat, unitary, and preformed from a tempered metallic material.
